(19) United States
(12) Patent Application Publication
(10) Pub. No.: US 2021/0383431 A1
(43) Pub. Date: Dec. 9, 2021

(54) CONTROL APPARATUS, SYSTEM, NON-TRANSITORY COMPUTER READABLE MEDIUM, TERMINAL APPARATUS, AND DETERMINATION METHOD

(71) Applicant: TOYOTA JIDOSHA KABUSHIKI KAISHA, Toyota-shi (JP)

(72) Inventors: Chikage KUBO, Chofu-shi (JP); Yusuke KOBAYASHI, Ota-ku (JP); Minoru KUBOTA, Toyota-shi (JP); Kentaro TAKAHASHI, Toyota-shi (JP); Hideo HASEGAWA, Nagoya-shi (JP); Takashi HORIGUCHI, Toyota-shi (JP)

(73) Assignee: TOYOTA JIDOSHA KABUSHIKI KAISHA, Toyota-shi (JP)

(21) Appl. No.: 17/315,675

(22) Filed: May 10, 2021

(30) Foreign Application Priority Data
Jun. 8, 2020 (JP) 2020-099680

(51) Int. Cl. G06Q 30/02; G06Q 50/30

(52) U.S. Cl. CPC G06Q 30/0259; G06Q 50/30; G06Q 30/0266; G06Q 30/0267

(57) ABSTRACT

A control apparatus includes a communication interface configured to communicate with a terminal apparatus configured to present, to a user outside a vehicle for delivering another user to a destination, a proposal to take the user to a place different from the destination by stopping off at the place using the vehicle together with an advertisement promoting the place, and a controller configured to determine, upon receipt by the communication interface of acceptance data indicating acceptance of the proposal, a location at which the user is to be picked up using the vehicle with reference to positional data indicating a position of the user.

### CROSS-REFERENCE TO RELATED APPLICATION

This application claims priority to Japanese Patent Application No. 2020-099680, filed on Jun. 8, 2020, the entire contents of which are incorporated herein by reference.

### TECHNICAL FIELD

The present disclosure relates to a control apparatus, a system, a program, a terminal apparatus, and a determination method.

### BACKGROUND

Patent Literature (PTL) 1 describes technology for calculating a second route via a candidate location to a specific reference location on a first route from the current position of a vehicle to a destination such that the candidate location exists in a predetermined range from the reference location, based on request information indicating a desired arrival time at which a user on board the vehicle desires to arrive at the destination and a desired action which the user desires to take by the desired arrival time.

### CITATION LIST

### Patent Literature

PTL 1: JP 2019-020172 A

### SUMMARY

In the technology described in PTL 1, a candidate location is recommended only to the user on board the vehicle.

It would be helpful to enable a proposal to, by allowing a user who is not on board a vehicle to share a ride, take the user to a place different from the destination of another user who has originally been on board.

A control apparatus according to the present disclosure includes:

a communication interface configured to communicate with a terminal apparatus configured to present, to a user outside a vehicle for delivering another user to a destination, a proposal to take the user to a place different from the destination by stopping off at the place using the vehicle together with an advertisement promoting the place; and

a controller configured to determine, upon receipt by the communication interface of acceptance data indicating acceptance of the proposal, a location at which the user is to be picked up using the vehicle with reference to positional data indicating a position of the user.

A program according to the present disclosure is configured to cause a computer to execute operations, the operations including:

presenting, to a user outside a vehicle for delivering another user to a destination, a proposal to take the user to a place different from the destination by stopping off at the place using the vehicle together with an advertisement promoting the place; and

transmitting, upon receipt of an operation to accept the proposal, acceptance data indicating acceptance of the proposal and positional data indicating a position of the user to a control apparatus configured to determine a location at which the user is to be picked up using the vehicle.

A determination method according to the present disclosure includes determining by a control apparatus, upon receipt of acceptance data from a terminal apparatus, a location at which a user outside a vehicle for delivering another user to a destination is to be picked up using the vehicle with reference to positional data indicating a position of the user, the terminal apparatus being configured to present, to the user, a proposal to take the user to a place different from the destination by stopping off at the place using the vehicle together with an advertisement promoting the place, the acceptance data indicating acceptance of the proposal.

According to the present disclosure, it is possible to make a proposal to, by allowing a user who is not on board a vehicle to share a ride, take the user to a place different from the destination of another user who has originally been on board.

### BRIEF DESCRIPTION OF THE DRAWINGS

In the accompanying drawings:

FIG. 1 is a diagram illustrating a configuration of a system according to an embodiment of the present disclosure;

FIG. 2 is a diagram illustrating a screen example of a first terminal apparatus according to the embodiment of the present disclosure;

FIG. 3 is a block diagram illustrating a configuration of a control apparatus according to the embodiment of the present disclosure;

FIG. 4 is a block diagram illustrating a configuration of the first terminal apparatus according to the embodiment of the present disclosure;

FIG. 5 is a block diagram illustrating a configuration of a second terminal apparatus according to the embodiment of the present disclosure;

FIG. 6 is a diagram illustrating operations of the system according to the embodiment of the present disclosure; and

FIG. 7 is a diagram illustrating operations of the system according to the embodiment of the present disclosure.

### DETAILED DESCRIPTION

Hereinafter, an embodiment of the present disclosure will be described with reference to the drawings.

In the drawings, the same or corresponding portions are denoted by the same reference numerals. In the descriptions of the present embodiment, detailed descriptions of the same or corresponding portions are omitted or simplified, as appropriate.

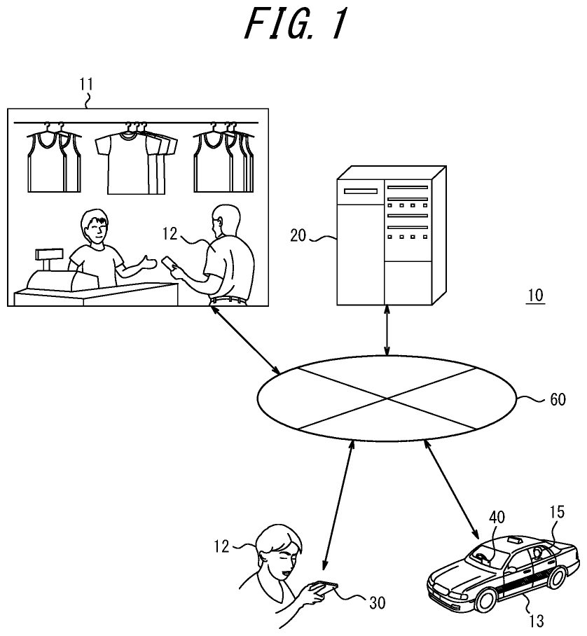

A configuration of a system 10 according to the present embodiment will be described with reference to FIG. 1.

The system 10 according to the present embodiment includes at least one control apparatus 20, at least one first terminal apparatus 30, and at least one second terminal apparatus 40.

The control apparatus 20 can communicate with the first terminal apparatus 30 and the second terminal apparatus 40 via a network 60.

The network 60 includes the Internet, at least one WAN, at least one MAN, or a combination thereof. The term “WAN” is an abbreviation of wide area network. The term “MAN” is an abbreviation of metropolitan area network. The network 60 may include at least one wireless network, at least one optical network, or a combination thereof. The wireless network is, for example, an ad hoc network, a cellular network, a wireless LAN, a satellite communication network, or a terrestrial microwave network. The term “LAN” is an abbreviation of local area network.

The control apparatus 20 is installed in a facility such as a data center. The control apparatus 20 is, for example, a server that belongs to a cloud computing system or another type of computing system.

The first terminal apparatus 30 is held by a first user 12. The first terminal apparatus 30 is, for example, a mobile device such as a mobile phone, a smartphone, or a tablet, or a PC. The term “PC” is an abbreviation of personal computer.

The second terminal apparatus 40 is mounted or installed in a vehicle 13. Alternatively, the second terminal apparatus 40 is held by a driver of the vehicle 13. The second terminal apparatus 40 is, for example, a vehicle-mounted device such as a car navigation device, a mobile device such as a mobile phone, a smartphone, or a tablet, or a PC.

The vehicle 13 is operated as a taxi or an on-demand bus and delivers a second user 15 who is a user different from the first user 12 to a destination in the present embodiment. The vehicle 13 is, for example, any type of automobile such as a gasoline vehicle, a diesel vehicle, an HV, a PHV, an EV, or an FCV. The term “HV” is an abbreviation of hybrid vehicle. The term “PHV” is an abbreviation of plug-in hybrid vehicle. The term “EV” is an abbreviation of electric vehicle. The term “FCV” is an abbreviation of fuel cell vehicle. The vehicle 13 is driven by a driver in the present embodiment, but the driving may be automated at any level. The automation level is, for example, any one of Level 1 to Level 5 according to the level classification defined by SAE. The name “SAE” is an abbreviation of Society of Automotive Engineers. The vehicle 13 may be a MaaS-dedicated vehicle. The term “MaaS” is an abbreviation of Mobility as a Service.

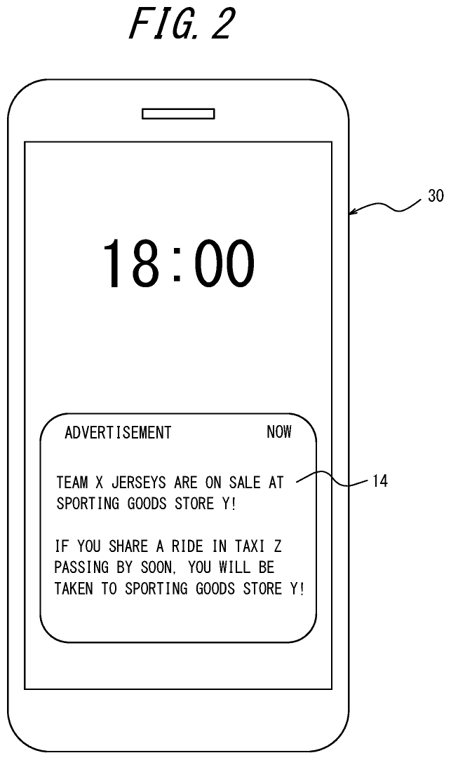

An outline of the present embodiment will be described with reference to FIGS. 1 and 2.

In the system 10 according to the present embodiment, the first terminal apparatus 30 presents, to a first user 12 outside the vehicle 13 for delivering a second user 15 to a destination, a proposal to take the first user 12 to a place 11 different from the destination by stopping off at the place 11 using the vehicle 13 together with an advertisement promoting the place 11. Then, the control apparatus 20 determines, upon receipt of acceptance data D5 indicating acceptance of the proposal from the first terminal apparatus 30, a location at which the first user 12 is to be picked up using the vehicle 13 with reference to positional data D1 indicating the position of the first user 12.

According to the present embodiment, it is possible to make a proposal to take the first user 12 to the place 11 different from the destination of the second user 15, who has originally been on board the vehicle 13, by allowing the first user 12, who is not on board, to share a ride.

In the present embodiment, a place 11 that sells goods or provides services, including a bank or a store such as a supermarket, a convenience store, a discount store, a department store, a toy store, a bookstore, an auto supply store, a clothing store, a sporting goods store, or a fast food store is promoted by an advertisement.

In the example of FIG. 2, a notification 14 is displayed on a screen of a smartphone serving as the first terminal apparatus 30. The notification 14 includes an advertisement promoting sporting goods store Y that serves as the place 11 with a message “Team X jerseys are on sale at sporting goods store Y!”. The notification 14 further includes a proposal to take the first user 12 to sporting goods store Y, which is different from the destination of the second user 15, by stopping off at sporting goods store Y by taxi Z that serves as the vehicle 13, in the form of a message “If you share a ride in taxi Z passing by soon, you will be taken to sporting goods store Y!”. In a case in which the proposal is accepted by the first user 12, the positional data D1 indicating the position of the first user 12 is transmitted from the first terminal apparatus 30 to the control apparatus 20. Then, a location at which the first user 12 is to be picked up using the vehicle 13 is determined with reference to the positional data D1.

Suppose that the second user 15 is en route in taxi Z toward the destination, which is unrelated to either team X or sporting goods store Y. Suppose that the first user 12 receives the notification 14 when walking outside, and accepts the proposal included in the notification 14. In this case, according to the present embodiment, a location at which the first user 12 is to be picked up by taxi Z is determined according to the position of the first user 12. Therefore, it is possible to take the first user 12 to sporting goods store Y, which is different from the destination of the second user 15, by allowing the first user 12 to share a ride in taxi Z. For example, for the first user 12, an advantage may arise in that if they see the advertisement included in the notification 14 and want to purchase a team X jersey, they can go to sporting goods store Y for a reasonable fee or for free by sharing a ride in taxi Z. For the second user 15, an advantage may arise in that they can have the first user 12 share a ride for part of the way to the destination by taxi Z and bear part of the boarding fee.

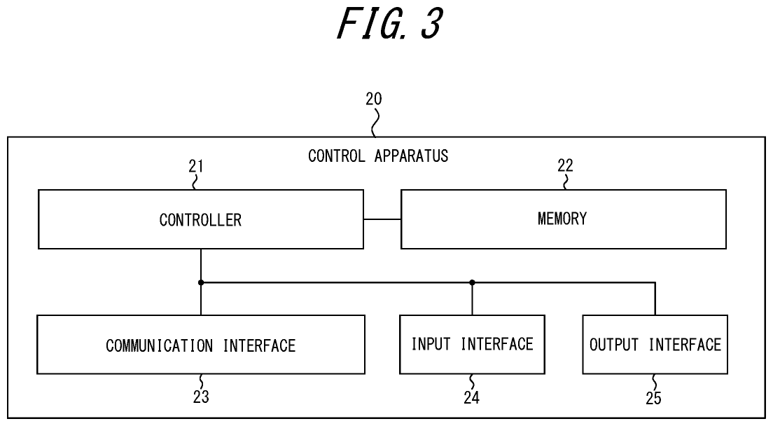

A configuration of the control apparatus 20 according to the present embodiment will be described with reference to FIG. 3.

The control apparatus 20 includes a controller 21, a memory 22, a communication interface 23, an input interface 24, and an output interface 25.

The controller 21 includes at least one processor, at least one dedicated circuit, or a combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The dedicated circuit is, for example, an FPGA or an ASIC. The term “FPGA” is an abbreviation of field-programmable gate array. The term

“ASIC” is an abbreviation of application specific integrated circuit. The controller 21 executes processes related to operations of the control apparatus 20 while controlling each component of the control apparatus 20.

The memory 22 includes at least one semiconductor memory, at least one magnetic memory, at least one optical memory, or a combination of at least two of these. The semiconductor memory is, for example, RAM or ROM. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The memory 22 functions as, for example, a main memory, an auxiliary memory, or a cache memory. The memory 22 stores data to be used for the operations of the control apparatus 20 and data obtained by the operations of the control apparatus 20.

The communication interface 23 includes at least one interface for communication. The interface for communication is, for example, a LAN interface. The communication interface 23 receives data to be used for the operations of the control apparatus 20, and transmits data obtained by the operations of the control apparatus 20.

The input interface 24 includes at least one interface for input. The interface for input is, for example, a physical key, a capacitive key, a pointing device, a touch screen integrally provided with a display, or a microphone. The input interface 24 accepts an operation for inputting data to be used for the operations of the control apparatus 20. The input interface 24, instead of being included in the control apparatus 20, may be connected to the control apparatus 20 as an external input device. As the connection method, any technology such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface.

The output interface 25 includes at least one interface for output. The interface for output is, for example, a display or a speaker. The display is, for example, an LCD or an organic EL display. The term “LCD” is an abbreviation of liquid crystal display. The term “EL” is an abbreviation of electro luminescence. The output interface 25 outputs data obtained by the operations of the control apparatus 20. The output interface 25, instead of being included in the control apparatus 20, may be connected to the control apparatus 20 as an external output device. As the connection method, any technology such as USB, HDMI®, or Bluetooth® can be used.

The functions of the control apparatus 20 are realized by execution of a control program according to the present embodiment by a processor serving as the controller 21. That is, the functions of the control apparatus 20 are realized by software. The control program causes a computer to execute the operations of the control apparatus 20, thereby causing the computer to function as the control apparatus 20. That is, the computer executes the operations of the control apparatus 20 in accordance with the control program to thereby function as the control apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read out a program directly from the portable medium and execute processing according to the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the control apparatus 20 may be realized by a dedicated circuit serving as the controller 21. That is, some or all of the functions of the control apparatus 20 may be realized by hardware.

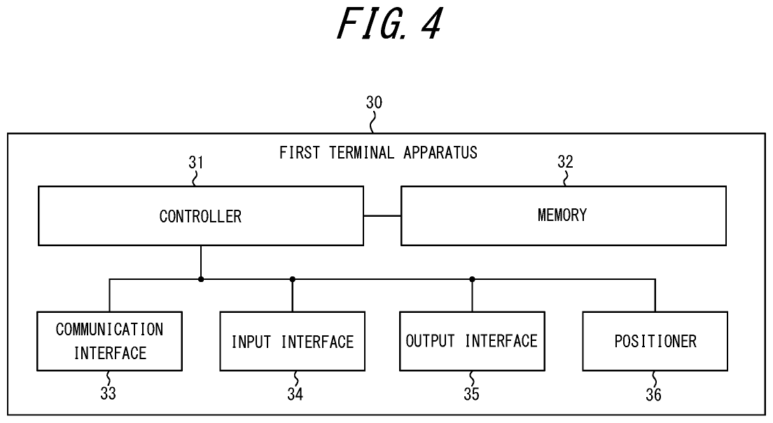

A configuration of the first terminal apparatus 30 according to the present embodiment will be described with reference to FIG. 4.

The first terminal apparatus 30 includes a controller 31, a memory 32, a communication interface 33, an input interface 34, an output interface 35, and a positioner 36.

The controller 31 includes at least one processor, at least one dedicated circuit, or a combination thereof. The processor is a general purpose processor such as a CPU or a GPU, or a dedicated processor that is dedicated to specific processing. The dedicated circuit is, for example, an FPGA or an ASIC. The controller 31 executes processes related to operations of the first terminal apparatus 30 while controlling each component of the first terminal apparatus 30.

The memory 32 includes at least one semiconductor memory, at least one magnetic memory, at least one optical memory, or a combination of at least two of these. The semiconductor memory is, for example, RAM or ROM. The RAM is, for example, SRAM or DRAM. The ROM is, for example, EEPROM. The memory 32 functions as, for example, a main memory, an auxiliary memory, or a cache memory. The memory 32 stores data to be used for the operations of the first terminal apparatus 30 and data obtained by the operations of the first terminal apparatus 30.

The communication interface 33 includes at least one interface for communication. The interface for communication is, for example, an interface compliant with a mobile communication standard such as LTE, the 4G standard, or the 5G standard, an interface compliant with a short-range wireless communication standard such as Bluetooth®, or a LAN interface. The term “LTE” is an abbreviation of Long Term Evolution. The term “4G” is an abbreviation of 4th generation. The term “5G” is an abbreviation of 5th generation. The communication interface 33 receives data to be used for the operations of the first terminal apparatus 30, and transmits data obtained by the operations of the first terminal apparatus 30.

The input interface 34 includes at least one interface for input. The interface for input is, for example, a physical key, a capacitive key, a pointing device, a touch screen integrally provided with a display, or a microphone. The input interface 34 accepts an operation for inputting data to be used for the operations of the first terminal apparatus 30. The input interface 34, instead of being included in the first terminal apparatus 30, may be connected to the first terminal apparatus 30 as an external input device. As the connection method, any technology such as USB, HDMI®, or Bluetooth® can be used.

The output interface 35 includes at least one interface for output. The interface for output is, for example, a display or a speaker. The display is, for example, an LCD or an organic EL display. The output interface 35 outputs data obtained by the operations of the first terminal apparatus 30. The output interface 35, instead of being included in the first terminal apparatus 30, may be connected to the first terminal apparatus 30 as an external output device. As the connection method, any technology such as USB, HDMI®, or Bluetooth® can be used.

The positioner 36 includes at least one GNSS receiver. The term “GNSS” is an abbreviation of global navigation satellite system. GNSS is, for example, GPS, QZSS, GLONASS, or Galileo. The term “GPS” is an abbreviation of Global Positioning System. The term “QZSS” is an abbreviation of Quasi-Zenith Satellite System. QZSS satellites are called quasi-zenith satellites. The term “GLONASS” is an abbreviation of Global Navigation Satellite System. The positioner 36 measures the position of the first terminal apparatus 30.

The functions of the first terminal apparatus 30 are realized by execution of a first terminal program according to the present embodiment by a processor serving as the controller 31. That is, the functions of the first terminal apparatus 30 are realized by software. The first terminal program causes a computer to execute the operations of the first terminal apparatus 30, thereby causing the computer to function as the first terminal apparatus 30. That is, the computer executes the operations of the first terminal apparatus 30 in accordance with the first terminal program to thereby function as the first terminal apparatus 30.

Some or all of the functions of the first terminal apparatus 30 may be realized by a dedicated circuit serving as the controller 31. That is, some or all of the functions of the first terminal apparatus 30 may be realized by hardware.

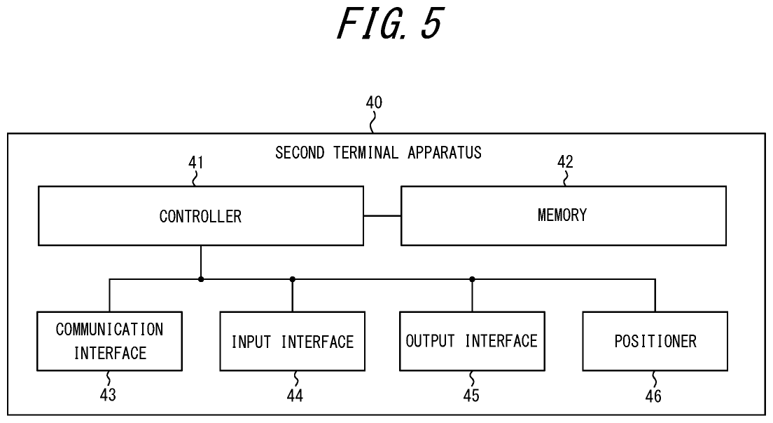

A configuration of the second terminal apparatus 40 according to the present embodiment will be described with reference to FIG. 5.

The second terminal apparatus 40 includes a controller 41, a memory 42, a communication interface 43, an input interface 44, an output interface 45, and a positioner 46.

The controller 41 includes at least one processor, at least one dedicated circuit, or a combination thereof. The processor is a general purpose processor such as a CPU or a GPU, or a dedicated processor that is dedicated to specific processing. The dedicated circuit is, for example, an FPGA or an ASIC. The controller 41 may include at least one ECU. The term “ECU” is an abbreviation of electronic control unit. The controller 41 executes processes related to operations of the second terminal apparatus 40 while controlling each component of the second terminal apparatus 40.

The memory 42 includes at least one semiconductor memory, at least one magnetic memory, at least one optical memory, or a combination of at least two of these. The semiconductor memory is, for example, RAM or ROM.

The RAM is, for example, SRAM or DRAM. The ROM is, for example, EEPROM. The memory 42 functions as, for example, a main memory, an auxiliary memory, or a cache memory. The memory 42 stores data to be used for the operations of the second terminal apparatus 40 and data obtained by the operations of the second terminal apparatus 40.

The communication interface 43 includes at least one interface for communication. The interface for communication is, for example, an interface compliant with a mobile communication standard such as LTE, the 4G standard, or the 5G standard, an interface compliant with a short-range wireless communication standard such as Bluetooth®, or a LAN interface. The communication interface 43 receives data to be used for the operations of the second terminal apparatus 40, and transmits data obtained by the operations of the second terminal apparatus 40.

The input interface 44 includes at least one interface for input. The interface for input is, for example, a physical key, a capacitive key, a pointing device, a touch screen integrally provided with a display, or a microphone. The input interface 44 accepts an operation for inputting data to be used for the operations of the second terminal apparatus 40. The input interface 44, instead of being included in the second terminal apparatus 40, may be connected to the second terminal apparatus 40 as an external input device. As the connection method, any technology such as USB, HDMI®, or Bluetooth® can be used.

The output interface 45 includes at least one interface for output. The interface for output is, for example, a display or a speaker. The display is, for example, an LCD or an organic EL display. The output interface 45 outputs data obtained by the operations of the second terminal apparatus 40. The output interface 45, instead of being included in the second terminal apparatus 40, may be connected to the second terminal apparatus 40 as an external output device such as a display audio. As the connection method, any technology such as USB, HDMI®, or Bluetooth® can be used.

The positioner 46 includes at least one GNSS receiver. GNSS is, for example, GPS, QZSS, GLONASS, or Galileo. The positioner 46 measures the position of the second terminal apparatus 40.

The functions of the second terminal apparatus 40 are realized by execution of a second terminal program according to the present embodiment by a processor serving as the controller 41. That is, the functions of the second terminal apparatus 40 are realized by software. The second terminal program causes a computer to execute the operations of the second terminal apparatus 40, thereby causing the computer to function as the second terminal apparatus 40. That is, the computer executes the operations of the second terminal apparatus 40 in accordance with the second terminal program to thereby function as the second terminal apparatus 40.

Some or all of the functions of the second terminal apparatus 40 may be realized by a dedicated circuit serving as the controller 41. That is, some or all of the functions of the second terminal apparatus 40 may be realized by hardware.

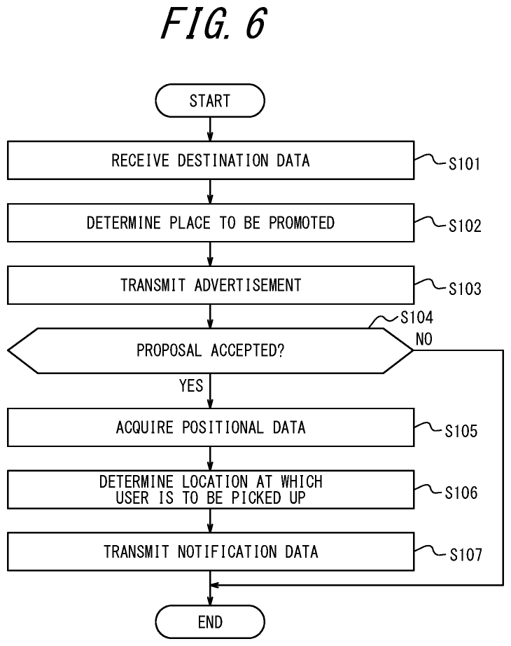

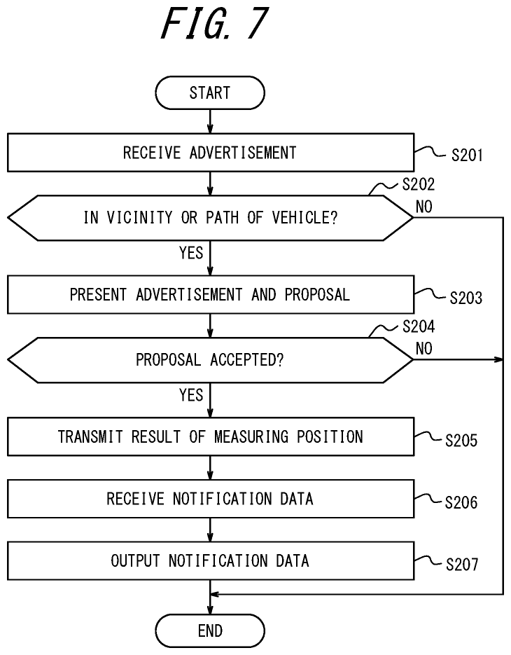

Operations of the system 10 according to the present embodiment will be described with reference to FIGS. 6 and 7. These operations correspond to a determination method according to the present embodiment. FIG. 6 illustrates operations of the control apparatus 20. FIG. 7 illustrates operations of the first terminal apparatus 30.

In step S101 of FIG. 6, the communication interface 23 of the control apparatus 20 receives destination data D2. The destination data D2 is data indicating the destination of a second user 15 who is to be delivered to the destination using the vehicle 13. The controller 21 of the control apparatus 20 acquires the destination data D2 received by the communication interface 23.

The destination data D2 may be transmitted to the control apparatus 20 in any procedure, but, in the present embodiment, is transmitted to the control apparatus 20 in the following procedure.

The controller 41 of the second terminal apparatus 40 accepts, with the input interface 44, an operation to input the destination data D2 by a driver of the vehicle 13. The controller 41 controls the communication interface 43 to transmit the input destination data D2. The communication interface 43 transmits the destination data D2 to the control apparatus 20.

In the example of FIG. 2, the controller 41 of the second terminal apparatus 40 accepts, with the input interface 44 such as a touch screen, an operation to input the destination data D2 by the driver of the vehicle 13 at the time when the second user 15 boards. The destination data D2 is data indicating the name, the address, or the position of the destination of the second user 15. The position is indicated by, for example, two-dimensional coordinates or three-dimensional coordinates.

The destination data D2 may be input to a terminal apparatus of the second user 15 such as a mobile phone, a smartphone, or a tablet, instead of the second terminal apparatus 40, and the destination data D2 may be transmitted from the terminal apparatus of the second user 15 to the control apparatus 20.

In step S102 of FIG. 6, the controller 21 of the control apparatus 20 determines a place 11 different from the destination according to the destination, and/or the position of the vehicle 13, before step 5201 of FIG. 7, namely, before a proposal to take a first user 12 outside the vehicle 13 to the place 11 by stopping off at the place 11 using the vehicle 13 is presented, to the first user 12, together with an advertisement promoting the place 11.

The place 11 may be determined in any procedure, but, in the present embodiment, is determined in the following procedure.

The positioner 46 of the second terminal apparatus 40 measures the position of the second terminal apparatus 40. The controller 41 of the second terminal apparatus 40 controls the communication interface 43 to transmit a result of measuring the position by the positioner 46. The communication interface 43 transmits, to the control apparatus 20, the result of measuring the position by the positioner 46 as positional data D3 indicating the position of the vehicle 13.

The communication interface 23 of the control apparatus 20 receives the positional data D3 transmitted from the second terminal apparatus 40. The controller 21 of the control apparatus 20 acquires the positional data D3 received by the communication interface 23.

The controller 21 of the control apparatus 20 retrieves a route R1 from the position of the vehicle 13 indicated by the acquired positional data D3 to the destination indicated by the destination data D2 acquired in step S101, with reference to map data D4. The map data D4 may be stored in advance in the memory 22 of the control apparatus 20, or may be accumulated in an external system such as an Internet-based GIS. The term “GIS” is an abbreviation of geographic information system. The controller 21 may retrieve the route R1 independently, or may retrieve the route R1 using an external system such as an Internet-based GIS. The controller 21 determines the place 11 according to the retrieved route R1. Specifically, the controller 21 determines, as the place 11, a location on the retrieved route R1 with reference to the map data D4. Locations which may be selected as the place 11 may be designated in advance. The controller 21 may determine, as the place 11, a location which is not on the retrieved route R1 in a case in which the difference in distance or required time between the route R1 and a route to reach the destination via the location is less than a first threshold V1. The controller 21 may calculate the distance or the required time independently, or may calculate the distance or the required time using an external system such as an Internet-based GIS.

In the example of FIG. 2, the controller 21 of the control apparatus 20 retrieves, as the route R1, a route from the position of taxi Z indicated by the positional data D3 to the position of the destination of the second user 15 that is identified by the name or the address of the destination of the second user 15 indicated by the destination data D2, or to the position of the destination of the second user 15 directly indicated by the destination data D2, with reference to the map data D4. Suppose that sporting goods store Y is on the route R1. Alternatively, suppose that the difference in distance or required time between the route R1 and a route to reach the destination of the second user 15 via sporting goods store Y is less than the first threshold V1. In this case, the controller 21 determines sporting goods store Y as the place 11.

The place 11 may be determined according to a positional relationship R2 with the destination, instead of the route R1 from the position of the vehicle 13 to the destination. Specifically, the controller 21 of the control apparatus 20 may determine, as the place 11, a location close to the destination indicated by the destination data D2 acquired in step S101, with reference to the map data D4. Whether a candidate location is close to the destination is determined by comparing the distance or the required time between the candidate location and the destination with a second threshold V2.

The place 11 may be determined according to a positional relationship R3 with the position of the vehicle 13, instead of the positional relationship R2 with the destination. Specifically, the controller 21 of the control apparatus 20 may determine, as the place 11, a location close to the position of the vehicle 13 indicated by the acquired positional data D3, with reference to the map data D4. Whether a candidate location is close to the position of the vehicle 13 is determined by comparing the distance or the required time between the candidate location and the position of the vehicle 13 with a third threshold V3.

In step S103 of FIG. 6, the controller 21 of the control apparatus 20 generates an advertisement promoting the place 11 determined in step S102. The controller 21 controls the communication interface 23 to transmit the generated advertisement. The communication interface 23 transmits the advertisement to the first terminal apparatus 30. In the present embodiment, the communication interface 23 transmits, to the first terminal apparatus 30, the positional data D3 that is received from the second terminal apparatus 40 and indicates the position of the vehicle 13, or route data DO indicating the route R1 retrieved by the controller 21, together with the advertisement.

In the example of FIG. 2, the controller 21 of the control apparatus 20 generates an advertisement promoting sporting goods store Y that serves as the place 11 with a message “Team X jerseys are on sale at sporting goods store Y!”. The controller 21 adds, to the generated advertisement, a proposal to take the first user 12 to sporting goods store Y, which is different from the destination of the second user 15, by stopping off at sporting goods store Y by taxi Z that serves as the vehicle 13, in the form of a message “If you share a ride in taxi Z passing by soon, you will be taken to sporting goods store Y!”.

In step S201 of FIG. 7, the communication interface 33 of the first terminal apparatus 30 receives, from the control apparatus 20, the advertisement transmitted in step S103 of FIG. 6. The controller 31 of the first terminal apparatus 30 acquires the advertisement received by the communication interface 33. In the present embodiment, the communication interface 33 receives the positional data D3 or the route data D0 transmitted in step S103 of FIG. 6 together with the advertisement. The controller 31 acquires the positional data D3 or the route data D0 received by the communication interface 33 together with the advertisement.

In step S202 of FIG. 7, the controller 31 of the first terminal apparatus 30 determines whether the first user 12 is or is not in the vicinity or the path of the vehicle 13. In a case in which the first user 12 is in the vicinity or the path of the vehicle 13, a process in step S203 is performed. In a case in which the first user 12 is in neither the vicinity nor the path of the vehicle 13, the flow of FIG. 7 ends.

Specifically, the positioner 36 of the first terminal apparatus 30 measures the position of the first terminal apparatus 30 as the position of the first user 12. The controller 31 of the first terminal apparatus 30 compares the distance or the required time from the position of the first user 12 measured by the positioner 36 to the position of the vehicle 13 indicated by the positional data D3 acquired in step 5201 with a fourth threshold V4. Alternatively, the controller 31 compares the distance or the required time from the position of the first user 12 measured by the positioner 36 to at least one location on the route R1 indicated by the route data D0 acquired in step S201 with a fifth threshold V5. In a case in which the distance or the required time from the position of the first user 12 to the position of the vehicle 13 is less than the fourth threshold V4, the controller 31 determines that the first user 12 is in the vicinity of the vehicle 13. In a case in which the distance or the required time from the position of the first user 12 to at least one location on the route R1 is less than the fifth threshold V5, the controller 31 determines that the first user 12 is in the path of the vehicle 13. In other cases, the controller 31 determines that the first user 12 is in neither the vicinity nor the path of the vehicle 13.

In step S203 of FIG. 7, the controller 31 of the first terminal apparatus 30 presents, to the first user 12, a proposal to take the first user 12 to the place 11 that is promoted by the advertisement acquired in step S201 by stopping off at the place 11 using the vehicle 13 together with the advertisement.

In the example of FIG. 2, the controller 31 of the first terminal apparatus 30 controls the output interface 35 such as a display to output a notification 14. The controller 31 includes, in the notification 14, the proposal added to the acquired advertisement together with the advertisement. Therefore, the notification 14 includes the advertisement promoting sporting goods store Y that serves as the place 11 with the message “Team X jerseys are on sale at sporting goods store Y!”. The notification 14 further includes the proposal to take the first user 12 to sporting goods store Y, which is different from the destination of the second user 15, by stopping off at sporting goods store Y by taxi Z that serves as the vehicle 13, in the form of the message “If you share a ride in taxi Z passing by soon, you will be taken to sporting goods store Y!”.

In step S204 of FIG. 7, in a case in which an operation to accept the proposal presented in step S203 by the first user 12 is performed, the controller 31 of the first terminal apparatus 30 accepts the operation with the input interface 34. The controller 31 generates acceptance data D5 indicating that the first user 12 has accepted the proposal. The controller 31 controls the communication interface 33 to transmit the generated acceptance data D5. The communication interface 33 transmits the acceptance data D5 to the control apparatus 20. Then, a process in step S205 is performed. In a case in which the operation to accept the proposal is not performed, the flow of FIG. 7 ends.

In the example of FIG. 2, the controller 31 of the first terminal apparatus 30 accepts, with the input interface 34 such as a touch screen, a GUI operation such as the first user 12 simply opening the notification 14, or opening the notification 14 and pressing an “accept” button. The term “GUI” is an abbreviation of graphical user interface.

In step S104 of FIG. 6, the controller 21 of the control apparatus 20 determines whether the proposal to take the first user 12 to the place 11 determined in step S102 by stopping off at the place 11 using the vehicle 13 has been accepted by the first user 12. In a case in which the proposal has been accepted by the first user 12, a process in step S105 is performed. In a case in which the proposal has not been accepted by the first user 12, the flow of FIG. 6 ends.

Specifically, in a case in which the acceptance data D5 is transmitted in step S204 of FIG. 7, the communication interface 23 of the control apparatus 20 receives the acceptance data D5. The controller 21 of the control apparatus 20 acquires the acceptance data D5 received by the communication interface 23. In this case, the controller 21 determines that the proposal to take the first user 12 to the place 11 by stopping off at the place 11 using the vehicle 13 has been accepted by the first user 12. In a case in which the acceptance data D5 is not transmitted in step S204 of FIG. 7, the acceptance data D5 is not received by the communication interface 23, and thus the controller 21 determines that the proposal has not been accepted by the first user 12.

In step S205 of FIG. 7, the controller 31 of the first terminal apparatus 30 controls the communication interface 33 to transmit a result of measuring the position by the positioner 36. The communication interface 33 transmits, to the control apparatus 20, the result of measuring the position by the positioner 36 as positional data D1 indicating the position of the first user 12.

In step S105 of FIG. 6, the communication interface 23 of the control apparatus 20 receives, from the first terminal apparatus 30, the positional data D1 transmitted in step S205 of FIG. 7. The controller 21 of the control apparatus 20 acquires the positional data D1 received by the communication interface 23.

In step S106 of FIG. 6, the controller 21 of the control apparatus 20 determines a location at which the first user 12 is to be picked up using the vehicle 13 with reference to the positional data D1 acquired in step S105. In the present embodiment, the controller 21 determines the location at which the first user 12 is to be picked up using the vehicle 13 according to the position of the vehicle 13 indicated by the positional data D3 received by the communication interface 23, or the retrieved route R1.

Specifically, the controller 21 determines, as the location at which the first user 12 is to be picked up using the vehicle 13, a location reachable in the shortest distance or the shortest time from the position of the vehicle 13 indicated by the positional data D3 received by the communication interface 23 with reference to the map data D4, the location being the position of the first user 12 indicated by the positional data D1 acquired in step S105 or being in the vicinity thereof. Alternatively, the controller 21 determines, as the location at which the first user 12 is to be picked up using the vehicle 13, a location on the retrieved route R1 with reference to the map data D4, the location being the position of the first user 12 indicated by the positional data D1 acquired in step 5105 or being in the vicinity thereof.

For example, suppose that the first user 12 is in a building and the vehicle 13 cannot enter the building. In this case, the controller 21 determines, as the location at which the first user 12 is to be picked up using the vehicle 13, a location either reachable in the shortest distance or the shortest time from the position of the vehicle 13, or on the route R1, the location being in, as the “vicinity” of the position of the first user 12, the surroundings of the building.

In step S107 of FIG. 6, the controller 21 of the control apparatus 20 generates notification data D6 indicating the location determined in step S106. The controller 21 controls the communication interface 23 to transmit the generated notification data D6. The communication interface 23 transmits the notification data D6 to the first terminal apparatus 30 and the second terminal apparatus 40.

In step S206 of FIG. 7, the communication interface 33 of the first terminal apparatus 30 receives, from the control apparatus 20, the notification data D6 transmitted in step S107 of FIG. 6. The controller 31 of the first terminal apparatus 30 acquires the notification data D6 received by the communication interface 33.

In step S207 of FIG. 7, the controller 31 of the first terminal apparatus 30 controls the output interface 35 to output the notification data D6 acquired in step S206 to the first user 12.

In the example of FIG. 2, the controller 31 of the first terminal apparatus 30 controls the output interface 35 such as a display to output the notification data D6.

Also in the second terminal apparatus 40, the notification data D6 is received and output. Specifically, the communication interface 43 of the second terminal apparatus 40 receives, from the control apparatus 20, the notification data D6 transmitted in step S107 of FIG. 6. The controller 41 of the second terminal apparatus 40 acquires the notification data D6 received by the communication interface 43. The controller 41 outputs the acquired notification data D6 to the driver of the vehicle 13. For example, the controller 41 controls the output interface 45 such as a display to output the notification data D6. The controller 41 may add the location indicated by the notification data D6 as a stop to the route guided by a car navigation system.

As described above, in the present embodiment, the communication interface 23 of the control apparatus 20 communicates with the first terminal apparatus 30, which presents, to a first user 12 outside a vehicle 13 for delivering a second user 15 to a destination, a proposal to take the first user 12 to a place 11 different from the destination by stopping off at the place 11 using the vehicle 13 together with an advertisement promoting the place 11. The controller 21 of the control apparatus 20 determines, upon receipt by the communication interface 23 of acceptance data D5 indicating acceptance of the proposal, a location at which the first user 12 is to be picked up using the vehicle 13 with reference to positional data D1 indicating the position of the first user 12.

Suppose that the second user 15 is en route in the vehicle 13 toward the destination. Suppose that the first user 12 receives an advertisement when walking outside, and accepts a proposal added to the advertisement. In this case, according to the present embodiment, a location at which the first user 12 is to be picked up using the vehicle 13 is determined according to the position of the first user 12. Therefore, it is possible to take the first user 12 to the place 11 different from the destination of the second user 15 by allowing the first user 12 to share a ride in the vehicle 13. That is, according to the present embodiment, it is possible to make a proposal to take the first user 12 to the place 11 different from the destination of the second user 15, who has originally been on board the vehicle 13, by allowing the first user 12, who is not on board, to share a ride.

As a variation of the present embodiment, the process in step 5202 of FIG. 7 may be omitted. Alternatively, instead of performing the process in step S202 of FIG. 7, it may be determined in the control apparatus 20 whether the first user 12 is or is not in the vicinity or the path of the vehicle 13. Then, in a case in which the first user 12 is in the vicinity or the path of the vehicle 13, the process in step S103 of FIG. 6 may be performed. Specifically, the controller 21 of the control apparatus 20 may control the communication interface 23 to transmit the advertisement in a case in which the distance or the required time from the position of the first user 12 indicated by the positional data D1 to the position of the vehicle 13 indicated by the positional data D3 received by the communication interface 23 is less than the fourth threshold V4. Alternatively, the controller 21 may control the communication interface 23 to transmit the advertisement in a case in which the distance or the required time from the position of the first user 12 indicated by the positional data D1 to at least one location on the retrieved route R1 is less than the fifth threshold V5. In this variation, the positional data D1 is transmitted from the first terminal apparatus 30 to the control apparatus 20 also prior to step S103. The positional data D1 may be transmitted from the first terminal apparatus 30 periodically in periods and intervals that are specified from the control apparatus 20, or may be transmitted from the first terminal apparatus 30 non-periodically at time points specified from the control apparatus 20.

The present disclosure is not limited to the embodiments described above. For example, a plurality of blocks described in the block diagrams may be integrated, or a block may be divided. Instead of executing a plurality of steps described in the flowcharts in chronological order in accordance with the description, the plurality of steps may be executed in parallel or in a different order according to the processing capability of the apparatus that executes each step, or as required. Other modifications can be made without departing from the spirit of the present disclosure.

For example, the control apparatus 20 may be mounted or installed in the vehicle 13. In that case, at least part of the operations of the second terminal apparatus 40 may be performed by the control apparatus 20. The second terminal apparatus 40 may be integrated with the control apparatus 20.

1. A control apparatus comprising:
a communication interface configured to communicate with a terminal apparatus configured to present, to a user outside a vehicle for delivering another user to a destination, a proposal to take the user to a place different from the destination by stopping off at the place using the vehicle together with an advertisement promoting the place; and
a controller configured to determine, upon receipt by the communication interface of acceptance data indicating acceptance of the proposal, a location at which the user is to be picked up using the vehicle with reference to positional data indicating a position of the user.

2. The control apparatus according to claim 1, wherein the controller is configured to determine the location at which the user is to be picked up using the vehicle according to a position of the vehicle.

3. The control apparatus according to claim 1, wherein the controller is configured to retrieve a route from a position of the vehicle to the destination, and determine the location at which the user is to be picked up using the vehicle according to the retrieved route.

4. The control apparatus according to claim 1, wherein
the controller is configured to generate notification data indicating the location at which the user is to be picked up using the vehicle, and
the communication interface is configured to transmit the notification data generated by the controller to the terminal apparatus.

5. The control apparatus according to claim 1, wherein
the controller is configured to generate notification data indicating the location at which the user is to be picked up using the vehicle, and
the communication interface is configured to transmit the notification data generated by the controller to another terminal apparatus mounted or installed in the vehicle.

6. The control apparatus according to claim 1, wherein
the controller is configured to generate the advertisement, and
the communication interface is configured to transmit the advertisement generated by the controller to the terminal apparatus.

7. The control apparatus according to claim 6, wherein the communication interface is configured to transmit other positional data indicating a position of the vehicle together with the advertisement to the terminal apparatus.

8. The control apparatus according to claim 6, wherein
the controller is configured to retrieve a route from a position of the vehicle to the destination, and
the communication interface is configured to transmit route data indicating the route retrieved by the controller together with the advertisement to the terminal apparatus.

9. The control apparatus according to claim 6, wherein the controller controls the communication interface to transmit the advertisement in a case in which a distance or required time from the position of the user indicated by the positional data to a position of the vehicle is less than a threshold.

10. The control apparatus according to claim 6, wherein the controller is configured to retrieve a route from a position of the vehicle to the destination, and controls the communication interface to transmit the advertisement in a case in which a distance or required time from the position of the user indicated by the positional data to at least one location on the retrieved route is less than a threshold.

11. The control apparatus according to claim 1, wherein the controller is configured to determine the place according to the destination before the proposal is presented together with the advertisement to the user.

12. The control apparatus according to claim 1, wherein the controller is configured to determine the place according to a position of the vehicle before the proposal is presented together with the advertisement to the user.

13. The control apparatus according to claim 1, wherein the controller is configured to retrieve a route from a position of the vehicle to the destination and determine the place according to the retrieved route before the proposal is presented together with the advertisement to the user.

14. A system comprising:
the control apparatus according to claim 1; and
a terminal apparatus configured to present the proposal together with the advertisement to the user.

15. A non-transitory computer readable medium storing a program configured to cause a computer to execute operations, the operations comprising:
presenting, to a user outside a vehicle for delivering another user to a destination, a proposal to take the user to a place different from the destination by stopping off at the place using the vehicle together with an advertisement promoting the place; and
transmitting, upon receipt of an operation to accept the proposal, acceptance data indicating acceptance of the proposal and positional data indicating a position of the user to a control apparatus configured to determine a location at which the user is to be picked up using the vehicle.

16. The non-transitory computer readable medium according to claim 15, wherein the operations further comprise receiving the advertisement from the control apparatus.

17. The non-transitory computer readable medium according to claim 16, wherein
the receiving includes receiving other positional data indicating a position of the vehicle together with the advertisement, and
the presenting includes presenting the proposal together with the advertisement in a case in which a distance or required time from the position of the user to the position of the vehicle indicated by the other positional data is less than a threshold.

18. The non-transitory computer readable medium according to claim 16, wherein
the receiving includes receiving route data indicating a route from a position of the vehicle to the destination together with the advertisement, and
the presenting includes presenting the proposal together with the advertisement in a case in which a distance or required time from the position of the user to at least one location on the route indicated by the route data is less than a threshold.

19. A terminal apparatus configured to execute the operations in accordance with the program stored in the non-transitory computer readable medium according to claim 15.

20. A determination method comprising determining by a control apparatus, upon receipt of acceptance data from a terminal apparatus, a location at which a user outside a vehicle for delivering another user to a destination is to be picked up using the vehicle with reference to positional data indicating a position of the user, the terminal apparatus being configured to present, to the user, a proposal to take the user to a place different from the destination by stopping off at the place using the vehicle together with an advertisement promoting the place, the acceptance data indicating acceptance of the proposal.
